(19) United States
(12) Patent Application Publication
(10) Pub. No.: US 2011/0236557 A1
(43) Pub. Date: Sep. 29, 2011

(54) MANUFACTURING METHOD OF FLAVOR-CONTAINING PARTICLE COMPOSITION

(75) Inventors: Hisashi Suzuki, Kanagawa (JP); Shougo Yoshida, Kanagawa (JP); Tetsuya Nakamura, Kanagawa (JP)

(73) Assignee: T. HASEGAWA CO., LTD, TOKYO (JP)

(21) Appl. No.: 12/998,825

(22) PCT Filed: Dec. 3, 2009
(86) PCT No.: PCT/JP2009/070286

§ 371 Date: Jun. 7, 2011

(30) Foreign Application Priority Data
Dec. 16, 2008 (JP) 2008-319349
Dec. 16, 2008 (JP) 2008-319350

(51) Int. Cl. A23L 1/221

(52) U.S. Cl. 426/601

(57) ABSTRACT

The present invention provides a manufacturing method of a flavor-containing particle composition characterized in that flavor, saccharide, and an oily substance having a softening point of 55 to 90° C. are mixed, the mixture is heated so as to bring the saccharide into a melted or a semi-melted state and then, cooled, solidified and crushed.

With the flavor-containing particle composition obtained by the manufacturing method of the present invention, there is no dissipation caused by sublimation of the flavor, the flavor is completely encapsulated, preservation stability of aroma is good, fluidity of the powder is high, blocking is hard to occur even under a high-humidity environment, and moreover, flavor release occurs at desirable timing. Furthermore, by increasing the grain size of the flavor-containing particle composition to some degree, a crispy feeling is provided, and if it is used in a food such as chewing gum, a crunchy, flaky and crispy feeling can be obtained and since flavor is released at the same time, the feeling is new and interesting.

### TECHNICAL FIELD

The present invention relates to a manufacturing method of a flavor-containing particle composition. More particularly, the present invention relates to a manufacturing method of a flavor-containing particle composition in which preservation stability of the flavor and fluidity are excellent, blocking is hard to occur, and flavor release occurs at desirable timing.

### BACKGROUND ART

Powdered flavors have been used for the purpose of flavoring various foods. The powdered flavors can be used for powder foods such as powder beverages, powder seasonings, soup stock cubes and the like and also they are useful as a material to be sprinkled on the surface of a snack or dry foods such as chewing gum and candies. Particularly, if a liquid flavor is used for chewing gum, a flavor is dissolved/absorbed in the chewing gum base and becomes difficult to be emitted into the mouth, whereby flavor development properties are deteriorated, which is a disadvantage, but if a powdered flavor is used, or particularly if encapsulated powdered flavor is used, as the capsule of an outer shell of the powder is dissolved, the flavor is released at appropriate timing, and extremely preferable effects are exerted, which is an advantage.

An encapsulation technology has been keenly researched as a method of solving volatility and instability particularly in the flavor field, and various methods have been developed as a method of sealing a flavor in a matrix of carbohydrates such as saccharide.

For example, Japanese Patent Laid-Open No. S49-62677 discloses a method in which a mixture consisting of sucrose and the like, starch hydrolyzate with DE20 or less and an emulsifier is heated, and an essential oil flavoring agent and a flavor component such as edible fat and the like is mixed therein and pushed out into a cold refrigerant so as to mold a capsule made of flavor-component containing fat, Japanese Examined Patent Application Publication No. S63-24652 discloses a manufacturing method of an edible fat capsule in which a saccharide mixture with a mass ratio of starch hydrolyzate with DE 5 to 12 and sucrose at 40:60 to 55:45 is heated and melted and edible oil containing a flavor and the like is dispersed in the heated and melted substance using an emulsifier and melted, pushed out and granulated by a heated extruder so as to encapsulate the same, Japanese Patent Laid-Open (translation of PCT Application) No. H7-502187 discloses a manufacturing method in which in encapsulation by extrusion, melting and granulation of a flavor, the melted substance is coagulated under a pressure sufficient to prevent volatilization in large quantity of a volatile component, Japanese Patent Laid-Open (translation of PCT Application) No. H9-507267 discloses a manufacturing method of a particulate aromatic composition in which a flavoring oil is uniformly mixed in a mixture in which mono or disaccharide, polysaccharide and water are mixed, melted, extruded and formed and a resulting particulate aromatic composition has a glass transition temperature at a room temperature or less, Japanese Patent No. 3444874 discloses a manufacturing method of a granular flavor in which a plate-shaped substance in a partially melted state is obtained by compressing a powder flavor prepared from a raw material containing a flavor and a diluting agent using a roller and the plate-shaped substance is crushed and granulated, Japanese Patent Laid-Open No. H11-276144 discloses a manufacturing method of a powder food containing fat in which at least one fat selected from a group consisting of edible fat and flavor oil and a powder food are uniformly mixed using a mixer or the like so as to obtain a mixture having a content of the fat of 0.5 to 40%, and the obtained mixture is subjected to processing by a dry compression granulation method without using a binder, and Japanese Patent Laid-Open (translation of PCT) No. 2008-510695 discloses a method in which rapid cooling of an extruded product for forming glass is performed using a refrigerant (liquid nitrogen, for example) of a low-temperature cooling agent less than −25° C. in a hot-melt extrusion method for manufacturing a flavor or fragrance delivery system.

However, with the technology for emulsifying and encapsulating a flavor or fat containing a flavor, since the flavor is brought into contact with directly heated and melted saccharide and exposed to a high temperature, the flavor can easily scatter, and since coating can easily become incomplete, the technology is susceptible to deviation or oxidation degradation over time caused by sublimation of the flavor, which is an unavoidable defect.

Also, attempts have been made in various mixing ways of saccharide compositions but in any case, since saccharide itself has relatively rich moisture-absorption characteristic, it has a defect that a preserving property is poor and consolidation is easy.

Therefore, emergence of a flavor-containing particle composition that solves the problems of stability of a flavor, blocking by moisture absorption of a powder and the like is in strong demand.

### SUMMARY OF INVENTION

### Technical Problem

An object of the present invention is to provide a manufacturing method of a flavor-containing particle composition in which no dissipation by sublimation of a flavor occurs during manufacturing, the flavor is completely encapsulated, preservation stability of aroma is good, particle has a high fluidability, blocking hardly occurs even under a high-humidity environment and moreover, flavor release occurs at desirable timing.

### Solution to Problem

The inventors have keenly researched a method of melting saccharide for encapsulation of flavor in order to solve the above problems and have found out that by having an oily substance such as a small amount of hardened oil or wax having a softening point somewhat higher than a ordinary temperature and lower than a melting point of a saccharide matrix contained in a melted substance of saccharide, the obtained flavor-containing particle composition is brought into a state coated with the oily substance, which is excellent in fluidity and hard to cause blocking even under a high-humidity environment.

Also, they have found out that when preparing a particle composition, by increasing the size of the particle to some degree, unique crispy feeling is obtained, and the crispy feeling can be obtained along with emergence of a flavor.

Moreover, they have found out that by using not a prior-art liquid flavor but using a flavor which has been powdered once as a flavor material to be used for encapsulation, dissipation by sublimation of the flavor no longer occurs, the flavor is completely encapsulated, and a flavor-containing particle composition of the obtained flavor composition whose preservation stability is good can be obtained and have completed the present invention.

As described above, the present invention provides a manufacturing method of a flavor-containing particle composition including:
(a) a process of mixing flavor, saccharide, and an oily substance having a softening point of 55 to 90° C. together and of heating the mixture so as to bring the saccharide into a melted or semi-melted state; and
(b) a process of cooling, solidifying, and crushing the mixture prepared in the process (a).

Also, the present invention is to provide a manufacturing method of a flavor-containing particle composition in which the flavor-containing particle composition has such a grain size that a portion passing through the opening size of 425 μm is 90% or more and is in a powder state.

Also, the present invention provides a manufacturing method of a flavor-containing particle composition in which the flavor-containing particle composition has such a grain size that a portion passing through the opening size of 2 mm and not passing through the opening size of 425 μm is 70% or more and is in a granular state with a crispy feeling.

Furthermore, the present invention provides a manufacturing method of a flavor-containing particle composition in which an oily substance having a softening point of 55 to 90° C. is contained in the flavor-containing particle composition in 0.5 to 30% in mass conversion.

Furthermore, the present invention provides a manufacturing method of a flavor-containing particle composition in which an oily substance having a softening point of 55 to 90° C. is one or more types selected from edible hardened fat, plant sterol, glycerin fatty acid ester, sucrose fatty acid ester, carnauba wax, rice wax, beeswax, and shellac.

Furthermore, the present invention provides a manufacturing method of a flavor-containing particle composition in which the flavor is a powdered flavor.

### Advantageous Effects of Invention

Since the flavor-containing particle composition obtained by the present invention has less dissipation by sublimation of aroma during manufacture, aroma of the flavor used as a material is favorably reproduced.

Also, since the flavor is completely encapsulated, preservation stability of aroma is good.

Moreover, since the surface of the particle composition is in a state coated with a solidified oily substance, if it is made into a powder state, powder has a high fluidability and blocking is hard to occur even under the high-humidity environment.

Moreover, if being used in a food such as chewing gum, flavor release occurs at desirable timing, and chewing gum with good aroma persistency can be obtained.

Furthermore, by increasing the size of a particle to some degree, a crispy feeling is realized, and if being used in a food such as chewing gum, a crunchy, flaky and crispy feeling can be obtained, and since flavor release occurs at the same time, the feeling is new and interesting.

### DESCRIPTION OF EMBODIMENTS

A manufacturing method of a flavor-containing particle composition of the present invention will be described in more detail.

The flavor used in the present invention is not particularly limited, and any of natural extracts such as various natural essential oils, extracts, oleoresin, resinoid and the like, synthetic flavor compounds or a blended flavor in which they are blended can be used. The natural essential oils include citrus essential oil such as orange, lemon, lime, grapefruit and the like and plant essential oils such as flower oil, peppermint oil, spearmint oil, spice oil, natural extracts include oily extract such as kola-nut extract, coffee extract, vanilla extract, cocoa extract, tea extract, spice extract and the like, resinoid and their oleoresins and the like, and synthetic flavor compounds include at least one or more types of synthetic flavor selected from a group of esters, alcohols, aldehydes, ketones, phenols, ethers, lactones, hydrocarbons, nitrogen-containing and/or sulfur-containing compounds and acids described in “Utilization Study on Food Flavor Compounds in Japan” (2000 Health Sciences Study Report; Japan Flavor & Fragrance Materials Association, published in March of 2001), “Synthetic Flavors—Chemistry and Product Knowledge” (enlarged and revised version issued on Mar. 22, 2005, by Motoichi Indo, The Chemical Daily) and the like.

As the flavor material, other than the above flavor compounds and natural flavors, various oil-soluble pigments, vitamins, functional substances and the like can be also used. The oil-soluble pigments include oil-soluble natural pigments such as β-carotene, paprika pigment, annatto pigment and chlorophyll and the like, oil-soluble vitamins include liver oil, vitamin A, vitamin A oil, vitamin D3, vitamin B2 butyric acid ester, vitamin E, vitamin F and the like, and the functional substances include docosahexaenoic acid (DHA), eicosapentaenoic acid (EPA), DHA- and/or EPA-containing fish oil, linoleic acid, γ-linolenic acid, α-linolenic acid, evening primrose oil, borage oil, recithin, octacosanol, rosemary extract, sage extract, γ-orizanol, β-carotene, palm carotene, perilla oil and the like.

In the present invention, as a flavor to be used as a material, those made into a powdered flavor in advance by using method of spray drying, vacuum drying, freezing drying and the like are preferably used. By using a powdered flavor, at the time when saccharide is brought into a melted or semi-melted state, an oily substance with the softening point of 55 to 90° C. and a flavor component do not mix, and dissipation and deterioration by volatilization of the flavor component caused by heating due to melting or semi-melting of saccharide can be suppressed.

In preparation of a powdered flavor, it can be obtained by emulsifying these oily materials by using a surfactant or an appropriate diluting agent such as fatty acid monoglyceride, fatty acid diglyceride, fatty acid triglyceride, propylene glycol fatty acid ester, sucrose fatty acid ester, polyglycerin fatty acid ester, recithin, chemically-modified starch, sorbitan fatty acid ester, quillai extract, gum Arabic, Tragacanth gum, guar gum, karaya gum, xanthan gum, pectin, alginic acid and its salts, carrageenan, gelatin, casein, dextrin, monosaccharide, disaccharide, polyol and the like and drying them using a drying method such as spray drying, vacuum drying, freeze drying and the like. In the present invention, the flavor which has been powdered once by using the above methods is made a material to be sealed in a hydrocarbon matrix, which is a big characteristic.

An amount of a flavor used in the present invention is not particularly limited, and 5 to 50% or preferably 10 to 40% in the flavor-containing particle composition, which is the invention of the present application, in mass conversion is preferable.

Saccharide that can be used as a material of a saccharide matrix to become an outer shell that seals the powder flavor in the present invention is not particularly limited, and any of monosaccharide, sugar alcohol of monosaccharide, disaccharide, sugar alcohol of disaccharide, oligosaccharide, polysaccharide and the like can be used. Among these saccharides, preferable saccharide includes xylitol, sucrose, glucose, fructose, lactose, trehalose, erythritol, maltitol and the like. These saccharides can be used singularly or two or more types of them can be used at the same time.

As an amount of saccharide to be used, any amount may be adopted as long as it is an amount sufficient to seal the flavor and to be a matrix, but 30 to 90%, preferably 40 to 85% or more preferably 50 to 80% in the flavor-containing particle composition, which is the invention of the present application, in mass conversion can be cited.

In the present invention, use of an oily substance having a softening point of 55 to 90° C. in the composition of the matrix is one big characteristic. Also, in using the oily substance, it is preferable that an emulsifier is not used in mixing the flavor, saccharide, and the oily substance. If the oily substance is dispersed in the melted saccharide without using an emulsifier, the oily substance is not emulsified or encapsulated but brought in a state kneaded in the melted saccharide. Therefore, after the melted saccharide is solidified, by crushing the same, the oily substance is brought into a state present on the surface of a crushed saccharide matrix and in which the obtained powder is coated with a film of the oily substance. Thus, the obtained powder has high fluidity and is hard to absorb moisture, and the flavor component is hard to sublime to the outside of the shell and moreover, since the flavor itself is hard to be in contact with air, it is hard to be subjected to oxidation deterioration.

The oily substance to be used needs to be an oily substance with the softening point of 55 to 90° C. If the softening point is less than 55° C., the oily substance is in the melted state even after the saccharide matrix is solidified. In this case, since the surface after the crushing is coated with the oily substance with fluidity, it makes the surface sticky, the powder particles bond to each other, whereby fluidity is lost, which is not desirable. Also, if the softening point exceeds 90° C., the oily substance remains to be solid even after saccharide is brought into a melted or semi-melted state, and the particles of the oily substance is brought into a state covered by saccharide, not a state in which the oily substance covers the surface of the saccharide.

The oily substances having the softening point of 55 to 90° C. that can be used in the present invention include, for example, edible hardened fat, plant sterol, glycerin fatty acid ester, sucrose fatty acid ester, carnauba wax (softening point at approximately 78 to 86° C.), rice wax (softening point at approximately 70 to 80° C.), beeswax, shellac (softening point at approximately 72 to 78° C.) and the like. Also, the edible hardened fat includes soy-bean hardened oil (softening point at approximately 60 to 70° C.), palm oil hardened oil (softening point at approximately 56 to 70° C.), rapeseed oil hardened oil (softening point at approximately 60 to 70° C.) and the like. The plant sterol includes stigmasterol, campesterol, brassicasterol, fucosterol and the like. The glycerin fatty acid ester includes monoglycerol fatty acid ester, diglycerol fatty acid ester, polyglycerol fatty acid ester and the like, and the fatty acid portion is preferably palmitic acid, stearic acid, arachidinic acid, and behenic acid. The sucrose fatty acid ester includes those with a fatty acid portion of palmitic acid, stearic acid, arachidinic acid, and behenic acid, for example. These oily substances can be used singularly or several types may be used in combination.

As an amount of the oily substance to be used, any amount may be adopted as long as it is an amount sufficient to cover the surface after the matrix by saccharide is crushed, but 0.5 to 30%, preferably 1 to 20% or more preferably 2 to 15% in the flavor-containing particle composition, which is the invention, in mass conversion can be cited.

In the present invention, the above flavor, saccharide, and oily substance with the softening point of 55 to 90° C. are mixed, and the mixture is heated so as to bring the saccharide into a melted or semi-melted state. At this time, it is preferable that the flavor, saccharide, and oily substance are mixed in a powder state in advance before melting. If the flavor is added after the saccharide only or the saccharide and oily substance are melted or semi-melted, the saccharide portion of the outer shell of the flavor itself is melted, and as a result, the flavor component itself is brought into direct contact with the melted saccharide matrix, which is not largely different from the prior-art encapsulation of the flavor by the saccharide matrix. Also, if the oily substances are added after only the saccharide or the flavor and the saccharide are melted or semi-melted, the melted saccharide matrix loses heat, which lowers the temperature of the matrix. In order to compensate for that, the melting temperature of the saccharide matrix needs to be set high, but in that case, the flavor is subjected to a high temperature, which is not preferable from the viewpoint of stability of the flavor and dissipation of a light boiling point portion by sublimation. Therefore, as for the oily substance having the softening point of 55 to 90° C. used in the present invention, a powder substance is preferably used, and the flavor, saccharide, and oily substance are preferably powder-mixed in advance by a powder mixer such as a stirring vessel, kneader, nauta mixer, ribbon mixer, extruder and the like.

In the present invention, the mixture of the flavor, saccharide, and oily substance is heated so as to melt or semi-melt the saccharide. A temperature to melt or semi-melt the saccharide at this time is preferably 80 to 130° C. and is a temperature above the softening point of the oily substance in use. If the temperature to melt or semi-melt the saccharide falls below 80° C., the saccharide is not melted or semi-melted, and uniform matrix cannot be formed, which is not preferable. Also, if the temperature to melt or semi-melt the saccharide exceeds 130° C., thermal deterioration of the flavor might be caused, which is not preferable. In order to bring the saccharide in a melted or semi-melted state, water is used as necessary. The heating and melting temperature of saccharide is different depending on the type of the saccharide, and if the saccharide is xylitol (melting point at 92 to 96° C.), for example, it is brought into the melted state at approximately 93° C., and there is no need to use water at all. However, depending on the type of the saccharide, if water is not used, the temperature to melt or semi-melt the saccharide might exceed 130° C., thus, by using water of approximately 0 to 15% in the flavor-containing particle composition in mass conversion, the temperature to melt or semi-melt the saccharide can be made lower than 130° C. A use amount of water and the temperature to melt or semi-melt the saccharide may be selected as appropriate in accordance with conditions including a saccharide composition to be used, a device and the like. Water is preferably mixed when the flavor, saccharide, and oily substance are powder-mixed.

A device that heats the mixture of them and melts or semi-melts saccharide may perform heating as it is if the powder mixer has a heating device such as a jacket, or the mixture may be fed into a heated extruder to be heated and extruded continuously. Also, if the extruder is to be used, mixing of the powder to melting or semi-melting by heating to extrusion can be performed continuously.

The object melted or semi-melted by heating can be withdrawn from the device and then, placed on a tray or the like and made into a thin film shape or a cord shape and solidified, for example. Also, at this time, by cooling the back side of a tray or the like by a cooling machine, the matrix can be efficiently solidified. Also, in the case of extrusion using an extruder or the like, solidification can be accomplished by cooling generated by deprivation of vaporization heat by extrusion under a cooled atmosphere and extrusion under a pressure-reduced atmosphere. On the other hand, since extrusion to a cooled refrigerant (ethanol, isopropanol and the like) washes off the oily substance on the matrix surface, it is not preferable in the present invention.

In the present invention, by crushing the obtained solidified substance by using an appropriate crushing machine, a flavor-containing powder composition or a flavor-containing granular composition with a crispy feeling can be obtained. Devices for crushing include a crushing machine such as a vibrating mill, a ball mill, a feather mill, a hammer mill, for example. By making the object pass through an exit having an appropriate mesh size or opening size using these crushing machines, the grain size of the obtained flavor-containing particle composition can be adjusted, and crushing can be performed so that a flavor-containing powder composition having a portion passing through the opening size of 425 μm at 90% or more or a flavor-containing granular composition with a crispy feeling having a portion passing through the opening size of 2 mm and not passing through the opening size of 425 μm at 70% or more can be obtained.

In order to obtain the flavor-containing powder composition having a portion passing through the opening size of 425 μm at 90% or more, crushing by the above-described crushing machine and passage through the exit with a mesh size of approximately 8.6 to 30 mesh (JIS Z-8801), that is, the opening size of approximately 0.5 mm (500 μm) to 2 mm can be exemplified, or preferably, a mesh size of approximately 16 to 30 mesh (JIS Z-8801), that is, the opening size of approximately 0.5 to 1 mm can be exemplified. By setting a portion of the flavor-containing particle composition passing through the opening size of 425 μm obtained by crushing at 90% or more, the powdery flavor-containing powder composition having a uniform grain size and a uniform flavor exerting characteristic can be obtained. The portion passing through the opening size of 425 μm at 90% or more means that if the powder is sieved using a sieve having the opening size of 425 μm, 90% or more of the original weight passes it, while the portion that cannot pass through the mesh is less than 10% of the weight before sieving.

Also, in order to obtain a flavor-containing granular composition with a crispy feeling with a portion passing through the opening size of 2 mm and not passing through the opening size of 425 μm at 70% or more, crushing by the above-described crushing machine and passage through the exit with a mesh size of approximately 6.5 to 10 mesh (JIS Z-8801), that is, the opening size of approximately 2.8 to 1.7 mm can be exemplified, or preferably, a mesh size of approximately 6.5 to 7.5 mesh (JIS Z-8801), that is, the opening size of approximately 2.8 to 2.36 mm can be exemplified. Also, if there are many fine powders, it is possible to sieve the object with approximately 36 to 60 mesh (JIS Z-8801) and to remove a part of the fine powders so as to adjust the object within the above range. The portion passing through the opening size of 2 mm and not passing through the opening size of 425 μm at 70% or more means that if the powder is sieved by using a sieve having the opening size of 2 mm and the passed portion is further sieved by using a sieve having the opening size of 425 μm, 70% or more of the original weight does not pass the opening size of 425 μm, or in other words, the amount of the portion not passing through the opening size of 2 mm and the portion having passed through the opening size of 425 μm added together is less than 30% of the original weight.

The opening size of 2 mm is an opening reference size of 8.6 mesh according to JIS Z-8801, and the opening size of 425 μm is an opening reference size of 36 mesh according to JIS Z-8801. The mesh size is a unit indicating fineness of a mesh and indicates the number of meshes per inch, but if the thickness of a mesh is large, the opening size becomes small even with the same mesh size, which makes simple comparison impossible, and the diameter of the exit is preferably specified by the opening size.

The flavor-containing particle composition obtained by the method of the present invention as above favorably reproduces aroma of the flavor used as the material since dissipation caused by sublimation of the aroma during manufacture is less, has good aroma stability over time since the flavor is completely encapsulated and since the entire surface is coated with wax, fluidity as particles is high, and blocking is hard to occur even under the high-humidity environment. Also, the composition has an excellent characteristic that flavor release occurs at desirable timing. Moreover, in the case of the flavor-containing granular composition with a crispy feeling, a crunchy, flaky and crispy feeling is provided, the texture of which can be tasted, and since flavor is released at the same time, the feeling is new and interesting.

Foods and beverages to which the flavor-containing particle composition of the present invention can be added include various foods and beverages such as chewing gum, tablet confectionary, candy, powder soup, snack foods, meat/fishery products, seasonings, instant foods, retort-packed foods, cooked foods, favorite foods and beverages and the like and other foods and beverages, and by adding an appropriate amount as an aroma/flavoring agent, seasoning or seasoning material to these foods and beverages, sublimation of an aroma component and a component change of the aroma component/taste component can be suppressed during processing and preservation, and good-quality aroma and flavor of the food material can be quickly tasted during eating and drinking, and foods and beverages with which satisfaction can be obtained can be provided, and moreover, if a flavor-containing granular composition with a crispy feeling is added, foods and beverages with which a crispy feeling can be obtained at the same time as exertion of a flavor can be provided.

### EXAMPLES

Examples are Cited Below and the Present Invention will be Described in More Detail.

### Reference Example 1

### Preparation of Lemon Powdered Flavor

After 300 g of chemically-modified starch and 400 g of dextrin were dissolved in 1300 g of soft water, 300 g of lemon oil was added, the product was emulsified by a homo mixer to an emulsified particle size of 0.5 to 2 μm, and an O/W emulsion was obtained. This emulsion was subjected to spray drying at a hot-air inlet temperature of 150° C., an exhaust-air temperature of 80° C., and atomizer rotation number of 20000 rpm by using a mobile-minor type spray drier (by Niro Japan), and 980 g of a powdered flavor containing 30% of lemon oil was obtained (reference product 1).

### Example 1

### The Present Invention Product

After 700 g of xylitol (melting point at 93° C.), 170 g of the reference product 1 and 130 g of rapeseed hardened fat powder (softening point at 67° C.) were mixed, the product was heated and melted by biaxial extruder EA-20 (by Suehiro EPM Corporation) and extruded from a die plate having a hole of 0.8 mm.

Extrusion condition: temperature when the mixture was melted: 92° C.
set temperature of die face: 70° C.
product temperature when extruded from die: 81° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 0.5 mm, and 970 g of a flavor-containing particle composition was obtained (the present invention product 1: lemon oil 5.1% contained). The present invention product 1 was sieved by 36 mesh (opening size of 425 μm) according to JIS Z-8801, and 96% thereof passed it.

### Comparative Example 1

### Oily Substance (Rapeseed Hardened Fat Powder) was Not Used for Solidification in Example 1

After 830 g of xylitol (melting point at 93° C.) and 170 g of the reference product 1 were mixed, the product was heated and melted by biaxial extruder EA-20 (by Suehiro EPM Corporation) and extruded from a die plate having a hole of 0.8 mm.

Extrusion condition: temperature when the mixture was melted: 92° C.
set temperature of die face: 70° C.
product temperature when extruded from die: 81° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 0.5 mm, and 970 g of a flavor-containing particle composition was obtained (Comparative Example product 1: lemon oil 5.1% contained). The Comparative Example product 1 was sieved by 36 mesh (opening size of 425 μm) according to JIS Z-8801, and 96% thereof passed it.

### Comparative Example 2

### Lemon Oil is Directly Sealed in a Matrix

After 51 g of chemically-modified starch, 68 g of dextrin, 700 g of xylitol, 51 g of lemon oil, and 130 g of the rapeseed hardened fat powder (softening point at 67° C.) were mixed, the product was heated and melted by biaxial extruder EA-20 (by Suehiro EPM Corporation) and extruded from a die plate having a hole of 0.8 mm.

Extrusion condition: temperature when the mixture was melted: 92° C.
set temperature of die face: 70° C.
product temperature when extruded from die: 81° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 0.5 mm, and 970 g of a flavor-containing particle composition was obtained (Comparative Example product 2: lemon oil 5.1% contained). The Comparative Example product 2 was sieved by 36 mesh (opening size of 425 μm) according to JIS Z-8801, and 96% thereof passed it.

### Comparative Example 3

### Instead of Hardened Oil in Example 1, Rapeseed White Oil was Used

After 700 g of xylitol (melting point at 93° C.), 170 g of the reference product 1, and 130 g of rapeseed white oil (softening point at −10° C.) were mixed, the product was heated and melted by biaxial extruder EA-20 (by Suehiro EPM Corporation) and extruded from a die plate having a hole of 0.8 mm.

Extrusion condition: temperature when the mixture was melted: 92° C.
set temperature of die face: 70° C.
product temperature when extruded from die: 81° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 0.5 mm, but crushed object bound together and did not pass the screen, and thus, a crushed object could not be obtained.

### Example 2

### Instead of Extrusion and Melting in Example 1, Melting in a Stirring Vessel and Solidification on a Tray were Used

After 700 g of xylitol (melting point at 93° C.), 170 g of the reference product 1, and 130 g of rapeseed hardened fat powder (raised melting point at 67° C.) were mixed, it was heated while being stirred and when the temperature was raised, hardened fat began to be melted at 60 to 65° C. and then, xylitol was brought into a semi-melted state at 90 to 95° C., and thus, heating was stopped at 94° C., and the product was poured into a stainless tray of 20 cm×30 cm (thickness of approximately 1.6 mm), cooled to a room temperature by blowing air and solidified and then, crushed by a power mill (by Dulton Co., Ltd.) with a screen diameter of 0.5 mm, and 970 g of a flavor-containing particle composition was obtained (the present invention product 2: lemon oil 5.1% contained). The present invention product 2 was sieved by 36 mesh (opening size of 425 μm) according to JIS Z-8801, and 96% thereof passed it.

### Example 3

### Saccharide was Changed to Sucrose and Rapeseed Hardened Fat Powder was Changed to Shellac in Example 1

After 700 g of sucrose (melting point at 185° C.), 170 g of the reference product 1, 130 g of shellac powder (softening point at 75° C.), and 49 g of water were mixed, the product was heated and melted by biaxial extruder EA-20 (by Suehiro EPM Corporation) and extruded from a die plate having a hole of 0.8 mm.

Extrusion condition: temperature when the mixture was melted: 118° C.
set temperature of die face: 85° C.
product temperature when extruded from die: 104° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 0.5 mm, and 970 g of a flavor-containing particle composition was obtained (the present invention product 3: lemon oil 5.1% contained). The present invention product 3 was sieved by 36 mesh (opening size of 425 μm) according to JIS Z-8801, and 96% thereof passed it.

### Example 4

### Saccharide was Changed to Glucose and Rapeseed Hardened Fat Powder was Changed to Palm Hardened Fat in Example 1

After 700 g of glucose (monohydrated crystal: melting point at 83° C.), 170 g of the reference product 1, 130 g of palm hardened fat powder (softening point at 70° C.), and 70 g of water were mixed, the product was heated and melted by biaxial extruder EA-20 (by Suehiro EPM Corporation) and extruded from a die plate having a hole of 0.8 mm.

Extrusion condition: temperature when the mixture was melted: 81° C.
set temperature of die face: 65° C.
product temperature when extruded from die: 70° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 0.5 mm, and 970 g of a flavor-containing particle composition was obtained (the present invention product 4: lemon oil 5.1% contained). The present invention product 4 was sieved by 36 mesh (opening size of 425 μm) according to JIS Z-8801, and 96% thereof passed it.

### Example 5

### Saccharide was Changed to Fructose and Rapeseed Hardened Fat Powder was Changed to Carnauba Wax in Example 1

After 700 g of fructose (anhydrous: melting point at 104° C.), 170 g of the reference product 1, and 130 g of carnauba wax powder (softening point at 84° C.) were mixed, the product was heated and melted by biaxial extruder EA-20 (by Suehiro EPM Corporation) and extruded from a die plate having a hole of 0.8 mm.

Extrusion condition: temperature when the mixture was melted: 103° C.
set temperature of die face: 70° C.
product temperature when extruded from die: 88° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 0.5 mm, and 970 g of a flavor-containing particle composition was obtained (the present invention product 5: lemon oil 5.1% contained). The present invention product 5 was sieved by 36 mesh (opening size of 425 μm) according to JIS Z-8801, and 96% thereof passed it.

### Example 6

### Saccharide was Changed to Trehalose and Rapeseed Hardened Fat Powder was Changed to Rice Wax in Example 1

After 700 g of trehalose (dehydrate crystal: melting point at 97° C.), 170 g of the reference product 1, and 130 g of rice wax powder (softening point at 75° C.) were mixed, the product was heated and melted by biaxial extruder EA-20 (by Suehiro EPM Corporation) and extruded from a die plate having a hole of 0.8 mm.

Extrusion condition: temperature when the mixture was melted: 97° C.
set temperature of die face: 70° C.
product temperature when extruded from die: 85° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 0.5 mm, and 970 g of a flavor-containing particle composition was obtained (the present invention product 6: lemon oil 5.1% contained). The present invention product 6 was sieved by 36 mesh (opening size of 425 μm) according to JIS Z-8801, and 96% thereof passed it.

### Example 7

### Saccharide was Changed to Lactose and Erythritol and Rapeseed Hardened Fat Powder was Changed to Soy-Bean Hardened Fat in Example 1

After 350 g of lactose (anhydrous α-D-lactose: melting point at 223° C.), 350 g of erythritol (anhydrous: melting point at 119° C.), 170 g of the reference product 1, 130 g of soy-bean hardened fat powder (softening point at 68° C.) and 70 g of water were mixed, the product was heated and melted by biaxial extruder EA-20 (by Suehiro EPM Corporation) and extruded from a die plate having a hole of 0.8 mm.

Extrusion condition: temperature when the mixture was melted: 105° C.
set temperature of die face: 75° C.
product temperature when extruded from die: 95° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 0.5 mm, and 970 g of a flavor-containing particle composition was obtained (the present invention product 7: lemon oil 5.1% contained). The present invention product 7 was sieved by 36 mesh (opening size of 425 μm) according to JIS Z-8801, and 96% thereof passed it.

### Example 8

### Test on Moisture-Absorbing Stability

The reference product 1, the present invention products 1 to 7, and the Comparative Examples 1 and 2 were sampled in 5 g each in a petri dish, the powder was laid uniformly and then, a moisture-absorbing test was conducted for 5 hours at the temperature of 40° C. and the relative humidity of 60%. The result is shown in Table 1.

TABLE 1
Moisture-absorbing test result

| Sample | Test result |
|---|---|
| Reference product 1 | No blocking but fluidity somewhat |
| | lowered. |
| Present invention product 1 | No blocking and favorable state. |
| Comparative example 1 | Blocking formed as a whole and |
| | not good. |
| Comparative example 2 | Blocking somewhat formed as a |
| | whole and not good. |
| Present invention product 2 | No blocking and favorable state. |
| Present invention product 3 | No blocking and favorable state. |
| Present invention product 4 | No blocking and favorable state. |
| Present invention product 5 | No blocking and favorable state. |
| Present invention product 6 | No blocking and favorable state. |
| Present invention product 7 | No blocking and favorable state. |

As illustrated in Table 1, the Comparative Example 1 (not using an oily substance) forms blocking, and the Comparative Example 2 (lemon oil is directly encapsulated in a matrix) somewhat forms blocking and their states are not good. Also, the reference product 1 (lemon oil powder flavor) does not form blocking, but fluidity is somewhat lowered, and an influence of moisture absorption is found.

On the other hand, the present invention products 1 to 7 maintain fully favorable states after the moisture-absorbing test, and it is found out that stability under a high humidity is extremely favorable.

### Example 9

### Test on Preservation Stability

The reference product 1, the present invention products 1 to 7, and the Comparative Examples 1 and 2 were sampled in 30 g each in a plastic bag with the size of 7 cm×11 cm and sealed, and a preservation test was conducted for 4 weeks at 40° C. in a dark place. The samples after preservation were diluted by water so as to become 0.1% (0.017% only for the reference product 1), and sensory evaluation was made by ten well-trained panellers. An average sensory evaluation result by the ten panellers is shown in Table 2.

TABLE 2
Taste after preservation test

| Sample | Test result |
|---|---|
| Reference product 1 | Deteriorated odor of lemon is |
| | strong. |
| Present invention product 1 | Fresh aroma of lemon is |
| | maintained, and deteriorated |
| | odor is not sensed. |
| Comparative example 1 | Deteriorated odor is not sensed, |
| | but fresh feeling of lemon is not |
| | sufficient. |
| Comparative example 2 | Fresh feeling of lemon is |
| | somewhat weakened, and |
| | deteriorated odor is somewhat |
| | sensed. |
| Present invention product 2 | Fresh aroma of lemon is |
| | maintained, and deteriorated |
| | odor is not sensed. |
| Present invention product 3 | Fresh aroma of lemon is |
| | maintained, and deteriorated |
| | odor is not sensed. |
| Present invention product 4 | Fresh aroma of lemon is |
| | maintained, and deteriorated |
| | odor is not sensed. |
| Present invention product 5 | Fresh aroma of lemon is |
| | maintained, and deteriorated |
| | odor is not sensed. |
| Present invention product 6 | Fresh aroma of lemon is |
| | maintained, and deteriorated |
| | odor is not sensed. |
| Present invention product 7 | Fresh aroma of lemon is |
| | maintained, and deteriorated |
| | odor is not sensed. |

As illustrated in Table 2, in the reference product 1 (powder flavor of lemon oil), deteriorated odor of lemon gets stronger by preservation, and the deteriorated odor is not sensed in the Comparative Example 1 (not using an oily substance), but fresh feeling is somewhat weakened.

Also, in the Comparative Example 2 (lemon oil is directly encapsulated in a matrix), fresh feeling of lemon is somewhat weakened, and deteriorated odor is a little generated.

On the other hand, in the present invention products 1 to 7, the fresh and favorable flavor of lemon is maintained after the preservation test, deteriorated odor is not sensed at all, and it is found out that preservation stability is extremely good.

### Example 10

### Flavoring Test on Chewing Gum and Sensory Evaluation: Flavor Emerging Test

The reference product 1, the present invention products 1 to 7, and the Comparative Examples 1 and 2 were added to the chewing gum base material shown below, respectively, mixed with a common procedure using a high-shear mixer at approximately 50° C. and cooled and then, pressure-extended and formed by a roller so as to prepare chewing gum, each piece weighing 3 g.

### Chewing Gum Base Material Composition

material, mixed amount (mass parts)
chewing gum base: 100
sugar: 250
glucose: 40
corn syrup (B×85): 60
glycerin: 3
the present invention product or Comparative Example: 4.5

(only the reference product 1 has a mixed amount of 0.765 mass parts)

This chewing gum was subjected to sensory evaluation by ten professional panellers.

An average sensory evaluation result by ten panellers is shown in Table 3.

TABLE 3
Flavor evaluation on flavor applied on chewing gum

| Sample | Sensory evaluation |
|---|---|
| Reference product 1 | Emergence of flavor is quick and |
| | strong but does not last long and |
| | the flavor is lost soon. |
| Present invention product 1 | Emergence of flavor is quick and |
| | strong and lasts for a long time. |
| Comparative example 1 | Emergence of flavor is somewhat |
| | delayed but strong. It lasts |
| | longer than the reference product |
| | but somewhat shorter than the |
| | present invention products. |
| Comparative example 2 | Emergence of flavor is slow and |
| | mild but weak and lacks in |
| | impact. |
| Present invention product 2 | Emergence of flavor is quick and |
| | strong and lasts for a long time. |
| Present invention product 3 | Emergence of flavor is quick and |
| | strong and lasts for a long time. |
| Present invention product 4 | Emergence of flavor is quick and |
| | strong and lasts for a long time. |
| Present invention product 5 | Emergence of flavor is quick and |
| | strong and lasts for a long time. |
| Present invention product 6 | Emergence of flavor is quick and |
| | strong and lasts for a long time. |
| Present invention product 7 | Emergence of flavor is quick and |
| | strong and lasts for a long time. |

As illustrated in Table 3, with the present invention products, emergence of flavor is quick and strong and lasts for a long time.

On the other hand, with the reference product 1 (powdered flavor of lemon oil), emergence of flavor is quick and strong but the flavor does not last long and is poor in persistency. Also, with the Comparative Example 1 (not using an oily substance), emergence of flavor is similar to that of the present invention products but the flavor does not last as long as the present invention products. Also, with the Comparative Example 2 (lemon oil is directly encapsulated in a matrix), emergence of flavor is slow and mild but weak and lacks in impact. This is considered to be because the flavor component is diluted by fat and further emulsified and dispersed in the matrix.

### Reference Example 2

### Preparation of Menthol Powdered Flavor

After 300 g of chemically-modified starch and 400 g of dextrin were dissolved in 1300 g of soft water, 300 g of menthol was added and the product was emulsified by a homo mixer to an emulsified particle size of 0.5 to 2 μm, and an O/W emulsion was obtained. This emulsion was subjected to spray drying at a hot-air inlet temperature of 150° C., an exhaust-air temperature of 80° C., and atomizer rotation number of 20000 rpm by using a mobile-minor type spray drier (by Niro Japan), and 980 g of a powdered flavor containing 30% of menthol was obtained (reference product 2).

### Example 11

### The Present Invention Product

After 700 g of xylitol (melting point at 93° C.), 170 g of the reference product 2 and 130 g of rapeseed hardened fat powder (softening point at 67° C.) were mixed, the product was heated and melted by biaxial extruder EA-20 (by Suehiro EPM Corporation) and extruded from a die plate having a hole of 0.8 mm.

Extrusion condition: temperature when the mixture was melted: 92° C.
set temperature of die face: 70° C.
product temperature when extruded from die: 81° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 2.0 mm, and 970 g of a flavor-containing granular composition with a crispy feeling was obtained (the present invention product 8: menthol 5.1% contained). The present invention product 8 was sieved by 8.6 mesh (opening size of 2.0 mm) according to JIS Z-8801, 98% thereof passed it and the passed part was further sieved by 36 mesh (opening size of 425 μm), and 85% of the original mass remained on the mesh.

### Comparative Example 4

### Oily Substance (Rapeseed Hardened Fat Powder) was not Used for Solidification in Example 11

After 830 g of xylitol (melting point at 93° C.) and 170 g of the reference product 2 were mixed, the product was heated and melted by biaxial extruder EA-20 (by Suehiro EPM Corporation) and extruded from a die plate having a hole of 0.8 mm.

Extrusion condition: temperature when the mixture was melted: 92° C.
set temperature of die face: 70° C.
product temperature when extruded from die: 81° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 2.0 mm, and 970 g of a flavor-containing granular composition with a crispy feeling was obtained (the Comparative Example product 3: menthol 5.1% contained). The Comparative Example product 3 was sieved by 8.6 mesh (opening size of 2.0 mm) according to JIS Z-8801, 98% thereof passed it and the passed part was further sieved by 36 mesh (opening size of 425 μm), and 85% of the original mass remained on the mesh.

### Comparative Example 5

### Menthol is Directly Sealed in a Matrix

After 51 g of chemically-modified starch, 68 g of dextrin, 700 g of xylitol, 51 g of menthol, and 130 g of the rapeseed hardened fat powder (softening point at 67° C.) were mixed, the product was heated and melted by biaxial extruder EA-20 (by Suehiro EPM Corporation) and extruded from a die plate having a hole of 0.8 mm.

Extrusion condition: temperature when the mixture was melted: 92° C.
set temperature of die face: 70° C.
product temperature when extruded from die: 81° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 2.0 mm, and 970 g of a flavor-containing granular composition with a crispy feeling was obtained (the Comparative Example product 4: menthol 5.1% contained). The Comparative Example product 4 was sieved by 8.6 mesh (opening size of 2.0 mm) according to JIS Z-8801, 98% thereof passed it and the passed part was further sieved by 36 mesh (opening size of 425 μm), and 85% of the original mass remained on the mesh.

### Comparative Example 6

### Instead of Hardened Oil in Example 1, Rapeseed White Oil was Used

After 700 g of xylitol (melting point at 93° C.), 170 g of the reference product 1, and 130 g of rapeseed white oil (softening point at −10° C.) were mixed, the product was heated and melted by biaxial extruder EA-20 (by Suehiro EPM Corporation) and extruded from a die plate having a hole of 0.8 mm.

Extrusion condition: temperature when the mixture was melted: 92° C.
set temperature of die face: 70° C.
product temperature when extruded from die: 81° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 2.0 mm, but crushed object bound together and did not pass the screen, and thus, a crushed object could not be obtained.

### Example 12

### Instead of Extrusion and Melting in Example 11, Melting in a Stirring Vessel and Solidification on a Tray were Used

After 700 g of xylitol (melting point at 93° C.), 170 g of the reference product 2, and 130 g of rapeseed hardened fat powder (softening point at 67° C.) were mixed, it was heated while being stirred and when the temperature was raised, hardened fat began to be melted at 60 to 65° C. and then, xylitol was brought into a semi-melted state at 90 to 94° C., and thus, heating was stopped at 94° C., and the product was poured into a stainless tray of 20 cm×30 cm (thickness of approximately 1.6 mm), cooled to a room temperature by blowing air and solidified and then, crushed by a power mill (by Dulton Co., Ltd.) with a screen diameter of 2.0 mm, and 970 g of a flavor-containing granular composition with a crispy feeling was obtained (the present invention product 9: menthol 5.1% contained). The present invention product 9 was sieved by 8.6 mesh (opening size of 2.0 mm) according to JIS Z-8801, 98% thereof passed it and the passed part was further sieved by 36 mesh (opening size of 425 μm), and 85% of the original mass remained on the mesh.

### Example 13

### Saccharide was Changed to Sucrose and Rapeseed Hardened Fat Powder was Changed to Shellac in Example 11

After 700 g of sucrose (melting point at 185° C.), 170 g of the reference product 1, 130 g of shellac powder (softening point at 75° C.), and 49 g of water were mixed, the product was heated and melted by biaxial extruder EA-20 (by Suehiro EPM Corporation) and extruded from a die plate having a hole of 0.8 mm.

Extrusion condition: temperature when the mixture was melted: 118° C.
set temperature of die face: 85° C.
product temperature when extruded from die: 104° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 2.0 mm, and 970 g of a flavor-containing granular composition with a crispy feeling was obtained (the present invention product 10: menthol 5.1% contained). The present invention product 10 was sieved by 8.6 mesh (opening size of 2.0 mm) according to JIS Z-8801, 98% thereof passed it and the passed part was further sieved by 36 mesh (opening size of 425 μm), and 85% of the original mass remained on the mesh.

### Example 14

### Saccharide was Changed to Glucose and Rapeseed Hardened Fat Powder was Changed to Palm Hardened Fat in Example 11

After 700 g of glucose (monohydrated crystal: melting point at 83° C.), 170 g of the reference product 1, 130 g of palm hardened fat powder (softening point at 70° C.), and 70 g of water were mixed, the product was heated and melted by biaxial extruder EA-20 (by Suehiro EPM Corporation) and extruded from a die plate having a hole of 0.8 mm.

Extrusion condition: temperature when the mixture was melted: 81° C.
set temperature of die face: 65° C.
product temperature when extruded from die: 70° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 2.0 mm, and 970 g of a flavor-containing granular composition with a crispy feeling was obtained (the present invention product 11: menthol 5.1% contained). The present invention product 11 was sieved by 8.6 mesh (opening size of 2.0 mm) according to JIS Z-8801, 98% thereof passed it and the passed part was further sieved by 36 mesh (opening size of 425 μm), and 85% of the original mass remained on the mesh.

### Example 15

### Saccharide was Changed to Fructose and Rapeseed Hardened Fat Powder was Changed to Carnauba Wax in Example 11

After 700 g of fructose (anhydrous: melting point at 104° C.), 170 g of the reference product 2, and 130 g of carnauba wax powder (softening point at 84° C.) were mixed, the product was heated and melted by biaxial extruder EA-20 (by Suehiro EPM Corporation) and extruded from a die plate having a hole of 0.8 mm.

Extrusion condition: temperature when the mixture was melted: 103° C.
set temperature of die face: 70° C.
product temperature when extruded from die: 88° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 2.0 mm, and 970 g of a flavor-containing granular composition with a crispy feeling was obtained (the present invention product 12: menthol 5.1% contained). The present invention product 12 was sieved by 8.6 mesh (opening size of 2.0 mm) according to JIS Z-8801, 98% thereof passed it and the passed part was further sieved by 36 mesh (opening size of 425 μm), and 85% of the original mass remained on the mesh.

### Example 16

### Saccharide was Changed to Trehalose and Rapeseed Hardened Fat Powder was Changed to Rice Wax in Example 2

After 700 g of trehalose (dehydrate crystal: melting point at 97° C.), 170 g of the reference product 2, and 130 g of rice wax powder (softening point at 75° C.) were mixed, the product was heated and melted by biaxial extruder EA-20 (by Suehiro EPM Corporation) and extruded from a die plate having a hole of 0.8 mm.

Extrusion condition: temperature when the mixture was melted: 97° C.
set temperature of die face: 70° C.
product temperature when extruded from die: 85° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 2.0 mm, and 970 g of a flavor-containing granular composition with a crispy feeling was obtained (the present invention product 13: menthol 5.1% contained). The present invention product 13 was sieved by 8.6 mesh (opening size of 2.0 mm) according to JIS Z-8801, 98% thereof passed it and the passed part was further sieved by 36 mesh (opening size of 425 μm), and 85% of the original mass remained on the mesh.

### Example 17

### Saccharide was Changed to Lactose and Erythritol and Rapeseed Hardened Fat Powder was Changed to Soy-Bean Hardened fat in Example 2

After 350 g of lactose (anhydrous α-D-lactose: melting point at 223° C.), 350 g of erythritol (anhydrous: melting point at 119° C.), 170 g of the reference product 2, 130 g of soy-bean hardened fat powder (softening point at 68° C.) and 70 g of water were mixed, the product was heated and melted by biaxial extruder EA-20 (by Suehiro EPM Corporation) and extruded from a die plate having a hole of 0.8 mm.

Extrusion condition: temperature when the mixture was melted: 105° C.
set temperature of die face: 75° C.
product temperature when extruded from die: 95° C.
screw rotation number: 60 rpm

The extruded mixture was placed in the cord state on a stainless tray so as not to overlap, cooled to a room temperature by blowing air and solidified and then, crushed by a power mill (by Dulton Co., Ltd.) with a screen diameter of 2.0 mm, and 970 g of a flavor-containing granular composition with a crispy feeling was obtained (the present invention product 14: menthol 5.1% contained). The present invention product 14 was sieved by 8.6 mesh (opening size of 2.0 mm) according to JIS Z-8801, 98% thereof passed it and the passed part was further sieved by 36 mesh (opening size of 425 μm), and 85% of the original mass remained on the mesh.

### Example 18

### Test on Moisture-Absorbing Stability

The reference product 2, the present invention products 8 to 14, and the Comparative Examples 3 and 4 were sampled in 5g each in a petri dish, the powder was laid uniformly and then, a moisture-absorbing test was conducted for 5 hours at the temperature of 40° C. and the relative humidity of 60%. The result is shown in Table 4.

Table 4: Moisture-Absorbing Test Result

TABLE 4
Moisture-absorbing test result

| Sample | Test result |
|---|---|
| Reference product 2 | No blocking but fluidity somewhat |
| | lowered. |
| Present invention product 8 | No blocking and favorable state. |
| Comparative example 3 | Blocking formed as a whole and |
| | not good. |
| Comparative example 4 | Blocking somewhat formed as a |
| | whole and not good. |
| Present invention product 9 | No blocking and favorable state. |
| Present invention product 10 | No blocking and favorable state. |
| Present invention product 11 | No blocking and favorable state. |
| Present invention product 12 | No blocking and favorable state. |
| Present invention product 13 | No blocking and favorable state. |
| Present invention product 14 | No blocking and favorable state. |

As illustrated in Table 4, the Comparative Example 3 (not using an oily substance) forms blocking, and the Comparative Example 4 (menthol is directly encapsulated in a matrix) somewhat forms blocking and their states are poor. Also, the reference product 2 (menthol powder flavor) does not form blocking, but fluidity is somewhat lowered, and an influence of moisture absorption is found.

On the other hand, the present invention products 8 to 14 maintain fully favorable states after the moisture-absorbing test, and it is found out that stability under a high humidity is extremely favorable.

### Example 19

### Test on Preservation Stability

The reference product 2, the present invention products 8 to 14, and the Comparative Examples 3 and 4 were sampled in 30 g each in a plastic bag with the size of 7 cm×11 cm and sealed, and a preservation test was conducted for 4 weeks at 40° C. in a dark place. As a control for each of them, those frozen (−20° C.) preserved were prepared. The samples after preservation were diluted in 0.1% water (0.017% for only the reference product 2), and sensory evaluation was made for intensity of the menthol feeling by ten well-trained panellers with the frozen preservation as a control. An average evaluation result by the ten panellers is shown in Table 5.

TABLE 5
Taste after preservation test

| Sample | Test result |
|---|---|
| Reference product 2 | Menthol feeling is apparently |
| | weak. |
| Present invention product 8 | Menthol feeling is not different |
| | from control. |
| Comparative example 3 | Menthol feeling is slightly weak. |
| Comparative example 4 | Menthol feeling is somewhat |
| | weak. |
| Present invention product 9 | Menthol feeling is not different |
| | from control. |
| Present invention product 10 | Menthol feeling is not different |
| | from control. |
| Present invention product 11 | Menthol feeling is not different |
| | from control. |
| Present invention product 12 | Menthol feeling is not different |
| | from control. |
| Present invention product 13 | Menthol feeling is not different |
| | from control. |
| Present invention product 14 | Menthol feeling is not different |
| | from control. |

As illustrated in Table 5, in the reference product 2 (powder flavor of menthol), the menthol feeling gets weaker by preservation, and in the Comparative Example 3 (not using an oily substance), the menthol feeling gets slightly weakened. Also, in the Comparative Example 4 (menthol is directly encapsulated in a matrix), the menthol feeling is somewhat weakened.

On the other hand, in the present invention products 8 to 14, sufficient menthol feeling is maintained after the preservation test, and it is found out that preservation stability is good.

### Example 20

### Flavoring Test on Chewing Gum and Sensory Evaluation: Flavor Emerging Test

The reference product 2, the present invention products 8 to 14, and the Comparative Examples 3 and 4 were added to the chewing gum base material shown below, respectively, mixed with a common procedure using a high-shear mixer at approximately 50° C. and cooled and then, pressure-extended and formed by a roller so as to prepare chewing gum, each piece weighing 3 g.

### Chewing Gum Base Material Composition

material, mixed amount (mass parts)
chewing gum base: 100
sugar: 250
glucose: 40
corn syrup (B×85): 60
glycerin: 3

the present invention product or Comparative Example: 4.5

(only the reference product 2 has a mixed amount of 0.765 mass parts)

This chewing gum was subjected to sensory evaluation by ten professional panellers.

The result is shown in Table 6.

TABLE 6
Flavor evaluation on flavor applied on chewing gum

| Sample | Sensory evaluation |
|---|---|
| Reference product 2 | A crispy feeling is not sensed at |
| | all. Emergence of menthol |
| | feeling is quick and strong but |
| | does not last long and the flavor |
| | is lost soon. |
| Present invention product 8 | A crispy feeling derived from |
| | granules is strongly sensed |
| | during chewing, and menthol |
| | flavor strongly emerges. Also, |
| | the menthol feeling lasts for a |
| | long time. |
| Comparative example 3 | A crispy feeling derived from |
| | granules is strongly sensed |
| | during chewing, and menthol |
| | flavor strongly emerges. |
| | However, persistency is better |
| | than the reference product but |
| | somewhat poorer than the |
| | present invention products. |
| Comparative example 4 | Emergence of menthol feeling is |
| | slow and mild but weak and lacks |
| | in impact. |
| Present invention product 9 | A crispy feeling derived from |
| | granules is strongly sensed |
| | during chewing, and menthol |
| | flavor strongly emerges. Also, |
| | the menthol feeling lasts for a |
| | long time. |
| Present invention product 10 | A crispy feeling derived from |
| | granules is strongly sensed |
| | during chewing, and menthol |
| | flavor strongly emerges. Also, |
| | the menthol feeling lasts for a |
| | long time. |
| Present invention product 11 | A crispy feeling derived from |
| | granules is strongly sensed |
| | during chewing, and menthol |
| | flavor strongly emerges. Also, |
| | the menthol feeling lasts for a |
| | long time. |
| Present invention product 12 | A crispy feeling derived from |
| | granules is strongly sensed |
| | during chewing, and menthol |
| | flavor strongly emerges. Also, |
| | the menthol feeling lasts for a |
| | long time. |
| Present invention product 13 | A crispy feeling derived from |
| | granules is strongly sensed |
| | during chewing, and menthol |
| | flavor strongly emerges. Also, |
| | the menthol feeling lasts for a |
| | long time. |
| Present invention product 14 | A crispy feeling derived from |
| | granules is strongly sensed |
| | during chewing, and menthol |
| | flavor strongly emerges. Also, |
| | the menthol feeling lasts for a |
| | long time. |

As illustrated in Table 6, with the present invention products, a crispy feeling derived from granules is strongly felt during chewing, flavor of menthol strongly emerges and moreover, the menthol feeling lasts for a long time.

On the other hand, with the reference product 2 (powdered flavor of menthol), a crispy feeling is not felt at all, and though emergence of flavor is quick and strong, the flavor does not last long, which results in a defect of poor persistency. Also, with the Comparative Example 3 (not using an oily substance), emergence of flavor is similar to that of the present invention products but the flavor does not last as long as the present invention products. Also, with the Comparative Example 4 (menthol is directly encapsulated in a matrix), emergence of flavor is slow and mild but weak and lacks in impact. This is considered to be because the flavor component is diluted by fat and further emulsified and dispersed in the matrix.

1. A manufacturing method of a flavor-containing particle composition comprising:
(a) a process of mixing flavor, saccharide, and an oily substance having a softening point of 55 to 90° C. together and of heating the mixture so as to bring the saccharide into a melted or semi-melted state; and
(b) a process of cooling, solidifying, and crushing the mixture prepared in the process (a).

2. The manufacturing method of a flavor-containing particle composition, according to claim 1, wherein
the flavor-containing particle composition has such a grain size that a portion passing through an opening size of 425 μm is 90% or more and is in a powder state.

3. The manufacturing method of a flavor-containing particle composition, according to claim 1, wherein
the flavor-containing particle composition has such a grain size that a portion passing through the opening size of 2 mm and not passing through the opening size of 425 μm is 70% or more and is in a granular state with a crispy feeling.

4. The manufacturing method of a flavor-containing particle composition, according to claim 1, wherein
an oily substance having a softening point of 55 to 90° C. is contained in the flavor-containing particle composition in 0.5 to 30% in mass conversion.

5. The manufacturing method of a flavor-containing particle composition, according to claim 1, wherein
an oily substance having a softening point of 55 to 90° C. is one or more types selected from edible hardened fat, plant sterol, glycerin fatty acid ester, sucrose fatty acid ester, carnauba wax, rice wax, beeswax, and shellac.

6. The manufacturing method of a flavor-containing particle composition, according to claim 1, wherein
the flavor is a powdered flavor.
